(19) United States
(12) Patent Application Publication
(10) Pub. No.: US 2026/0052430 A1
(43) Pub. Date: Feb. 19, 2026

(54) TECHNIQUES FOR PROTOCOL DATA UNIT SIZE DETERMINATION

(71) Applicant: QUALCOMM Incorporated, San Diego, CA (US)

(72) Inventors: Sherif ELAZZOUNI, San Diego, CA (US); Gavin Bernard HORN, La Jolla, CA (US); Ozcan OZTURK, San Diego, CA (US)

(21) Appl. No.: 18/802,969

(22) Filed: Aug. 13, 2024

(51) Int. Cl. H04W 28/06

(52) U.S. Cl. CPC H04W 28/065

(57) ABSTRACT

Methods, systems, and devices for method for wireless communication are described. A user equipment (UE) may receive, at a packet data convergence protocol layer of the UE, a set of service data units for an uplink transmission. Th UE may then concatenate the set of service data units to generate a concatenated service data unit in accordance with a concatenation policy generated by a machine learning model. The machine learning model may be based on a radio condition, a traffic type associated with the set of service data units, an internal condition associated with the UE, a network configuration including a range threshold or a performance threshold or both, or any combination thereof. The UE may then transmit the uplink transmission including the concatenated service data unit.

### FIELD OF TECHNOLOGY

The following relates to method for wireless communication, including techniques for protocol data unit size determination.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, at a packet data converge protocol layer of the UE, a set of multiple service data units for an uplink transmission, concatenating the set of multiple service data units to generate a concatenated service data unit in accordance with a concatenation policy generated by a machine learning model based on a radio condition associated with the set of multiple service data units, a traffic type associated with the set of multiple service data units, an internal condition associated with the UE, a network configuration including a range threshold or a performance threshold or both, or any combination thereof, and transmitting the uplink transmission including the concatenated service data unit.

A UE for wireless communications is described. The UE may include one or more memories storing processor executable code, and one or more processors coupled with the one or more memories. The one or more processors may individually or collectively be operable to execute the code to cause the UE to receive, at a packet data converge protocol layer of the UE, a set of multiple service data units for an uplink transmission, concatenate the set of multiple service data units to generate a concatenated service data unit in accordance with a concatenation policy generated by a machine learning model based on a radio condition associated with the set of multiple service data units, a traffic type associated with the set of multiple service data units, an internal condition associated with the UE, a network configuration including a range threshold or a performance threshold or both, or any combination thereof, and transmit the uplink transmission including the concatenated service data unit.

Another UE for wireless communications is described. The UE may include means for receiving, at a packet data converge protocol layer of the UE, a set of multiple service data units for an uplink transmission, means for concatenating the set of multiple service data units to generate a concatenated service data unit in accordance with a concatenation policy generated by a machine learning model based on a radio condition associated with the set of multiple service data units, a traffic type associated with the set of multiple service data units, an internal condition associated with the UE, a network configuration including a range threshold or a performance threshold or both, or any combination thereof, and means for transmitting the uplink transmission including the concatenated service data unit.

A non-transitory computer-readable medium storing code for wireless communications is described. The code may include instructions executable by one or more processors to receive, at a packet data converge protocol layer of the UE, a set of multiple service data units for an uplink transmission, concatenate the set of multiple service data units to generate a concatenated service data unit in accordance with a concatenation policy generated by a machine learning model based on a radio condition associated with the set of multiple service data units, a traffic type associated with the set of multiple service data units, an internal condition associated with the UE, a network configuration including a range threshold or a performance threshold or both, or any combination thereof, and transmit the uplink transmission including the concatenated service data unit.

Some examples of the method, UEs, and non-transitory computer-readable medium described herein may further include operations, features, means, or instructions for transmitting, to a server hosting the machine learning model or to a network entity, a target concatenated service data unit size for the set of multiple service data units, a target concatenation timer for the set of multiple service data units, a set of multiple logs associated with a set of multiple concatenated service data unit sizes, a set of multiple statistics associated with a set of multiple concatenated service data unit sizes, a latency associated with concatenation buffering, one or more performance parameters, or any combination thereof.

In some examples of the method, UEs, and non-transitory computer-readable medium described herein, the one or more performance parameters include at least one of a quantity of grants missed due to concatenation, an excess latency associated with concatenation, a throughput associated with concatenation, a channel occupancy time associated with concatenation, or any combination thereof.

Some examples of the method, UEs, and non-transitory computer-readable medium described herein may further include operations, features, means, or instructions for transmitting a message indicating one or more of a capability of the UE to concatenate traffic with a threshold quantity of concatenation streams, a model accuracy, a throughput with concatenation supported at the UE, or any combination thereof.

In some examples of the method, UEs, and non-transitory computer-readable medium described herein, transmitting the uplink transmission may include operations, features, means, or instructions for transmitting a protocol data unit including the concatenated service data unit, one or more concatenation headers and one or more packet data converge protocol headers.

Some examples of the method, UE), and non-transitory computer-readable medium described herein may further include operations, features, means, or instructions for receiving a control message including a set of configuration parameters associated with the concatenation policy.

In some examples of the method, UEs, and non-transitory computer-readable medium described herein, the set of configuration parameters includes a minimum time to hold service data units in a concatenation buffer, a maximum time to hold service data units in the concatenation buffer, a minimum size of concatenated service data units supported by the UE, a maximum size of concatenated service data units supported by the UE, an indication of whether a use of the machine learning model may be allowed, one or more quality of service flows associated with the machine learning model, or any combination thereof.

Some examples of the method, UEs, and non-transitory computer-readable medium described herein may further include operations, features, means, or instructions for receiving a control message indicating a threshold quantity of missed grants, a target segmentation rate, a target throughput value, a target latency value, or any combination thereof, where the concatenation policy may be based on the control message.

In some examples of the method, UEs, and non-transitory computer-readable medium described herein, the concatenation policy includes a concatenated service data unit size for the set of multiple service data units or a concatenation timer for the set of multiple service data units, or both.

In some examples of the method, UEs, and non-transitory computer-readable medium described herein, the concatenation policy may be configured for each bearer, each quality of service flow, each reordering domain, each traffic categorization, or any combination thereof.

In some examples of the method, UEs, and non-transitory computer-readable medium described herein, the radio condition associated with the set of multiple service data units includes a frequency of grant allocation, a transport block size, a hybrid automatic repeat request success rate, or any combination thereof.

In some examples of the method, UEs, and non-transitory computer-readable medium described herein, the traffic type associated with the set of multiple service data units includes a latency sensitive traffic.

In some examples of the method, UEs, and non-transitory computer-readable medium described herein, the internal condition associated with the UE includes a processing capability, a power of the UE, a throughput at the UE, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for protocol data unit size determination in accordance with one or more aspects of the present disclosure.

FIG. 2 shows an example of a wireless communications system that supports techniques for protocol data unit size determination in accordance with one or more aspects of the present disclosure.

FIG. 3 shows an example of a concatenated service data unit structure that supports techniques for protocol data unit size determination in accordance with one or more aspects of the present disclosure.

FIG. 4 shows an example of a process flow that supports techniques for protocol data unit size determination in accordance with one or more aspects of the present disclosure.

FIGS. 5 and 6 show block diagrams of devices that support techniques for protocol data unit size determination in accordance with one or more aspects of the present disclosure.

FIG. 7 shows a block diagram of a communications manager that supports techniques for protocol data unit size determination in accordance with one or more aspects of the present disclosure.

FIG. 8 shows a diagram of a system including a device that supports techniques for protocol data unit size determination in accordance with one or more aspects of the present disclosure.

FIGS. 9 through 11 show flowcharts illustrating methods that support techniques for protocol data unit size determination in accordance with one or more aspects of the present disclosure.

### DETAILED DESCRIPTION

A wireless communications system may support layer 2 concatenation to reduce overhead, UE power consumption, security overhead, packet generation overhead, heterogenous payloads reducing efficiency, header processing at multiple layers, among others. In some cases, a UE may concatenate multiple service data units to generate a concatenated service data unit. By transmitting a concatenated service data unit instead of multiple service data units, the wireless communications system may save on processing time related to initialization and security key setup for each service data unit. A UE may generate a concatenated service data unit using two parameters—a concatenation timer and a maximum service data unit size. In some examples, the concatenation timer may be based on the maximum allowable delay of the bearer or quality of service flow. Additionally, or alternatively, the maximum service data unit size may either be based on the capability of the UE or be based on UE implementation. In some examples, the parameters associated with the concatenated service data unit may be predefined and may not be adjusted according to the specific service data units that are to be concatenated.

According to one or more aspects of the present disclosure, a UE may implement a machine learning model (artificial intelligence model) to determine the parameters for a concatenated service data unit. The UE may implement the machine learning model to determine a concatenation policy for the incoming service data units at a Packet Data Convergence Protocol (PDCP) layer of the UE. The concatenation policy may define a concatenated service data unit size and a concatenation format for the service data units. The machine learning model may generate the concatenation policy based on radio conditions, traffic, or one or more UE internal conditions. In some cases, the machine learning model may be built (e.g., trained or updated) and implemented at the UE. In other cases, the UE may send service data unit information to an artificial intelligence or machine learning server or to the network entity for further processing. The UE may also transmit capability information and one or more processing constraints for inputting into the machine learning model. Thus, by implementing the techniques depicted herein, instead of concatenating the service data units according to a predefined concatenation policy, a UE may implement a concatenation policy generated for the service data units and one or more conditions at the UE.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to techniques for protocol data unit size determination.

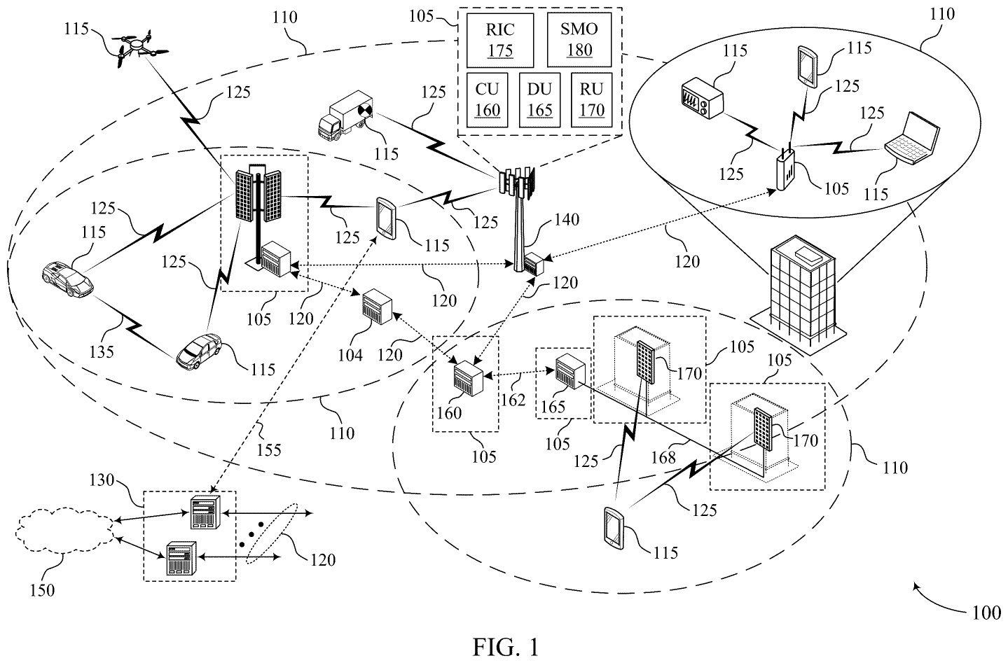

FIG. 1 shows an example of a wireless communications system 100 that supports techniques for protocol data unit size determination in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), PDCP). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, wireless communications devices may communicate in accordance with a service data unit concatenation procedure at the PDCP layer. The concatenation of service data units at a UE 115 may reduce layer 2 complexity at the UE 115. Concatenation of service data units may help implementation of integrity protection by communicating with hardware accelerators at a slower rate (with larger service data units). In some cases, there may be a reduction in overhead of communication by adding relevant headers for every service data unit. The header may include a PDCP layer, a RLC layer or a MAC layer. In some cases, the UE 115 may communicate across user plane traffic with concatenation in the PDCP layer.

As depicted herein, the UE 115 may apply layer 2 concatenation of service data units. The UE 115 may implement layer 2 header processing enhancements including reducing user plane integrity protection (UPIP) overhead, UE power consumption, security overhead, packet generation overhead, heterogenous payloads reducing efficiency, header processing at multiple layers, among others. In some instances, processing overhead may scale linearly with a quantity of packets. An uplink data rate may be less than a downlink data rate, but a same quantity of packets may be processed due to feedback and similar processing load.

The UE 115 may implement service data unit concatenation at the PDCP layer. The concatenated service data units may be processed with a one-time initialization and key expansion, which reduces the UPIP processing time. In some instances, the UE 115 may operate according to a data processing capacity of a hardware accelerator, which in some cases may be a predefined quantity of bytes (e.g., 9000 bytes). Alternatively, the UE 115 may not fully utilize the data processing capacity of the hardware accelerator (e.g., the UE 115 may process 1500 bytes with a capacity of 9000 bytes). In some examples, the UE 115 may operate according to a processing capacity of layer 2 headers (e.g., may have a capability to process 1.6 million layer 2 headers per second at 20 Gbps).

Additionally, or alternatively, the UE 115 may communicate by utilization of concatenation of service data units, where a structure of PDCP packet data unit is constructed by concatenation in accordance with allocation of a count value. The UE 115 may perform transmit operations and receive operations with PDCP concatenation. In some examples, the UE 115 may support mobility, carrier aggregation, and dual connectivity, with handling data up the predefined data processing capacity and a dominant factor of cryptographic data. In some cases, the dominant factor of the cryptographic processing time may include the initialization and key setup time, which can be reduced by single execution per multiple PDCP SDUs consuming one initialization and security key setup. Thus, use of concatenated service data units at the PDCP layer provides for lower overhead, a lower cryptographic processing time, amenability for hardware engine utilization, a lower quantity of hardware invocations, a higher throughput, or any combination thereof.

Aspects of the present disclosure provide for concatenation of a set of service data units in accordance with implementing a machine learning model. In particular, a UE 115 may receive, at a PDCP layer of the UE 115, a set of service data units for an uplink transmission. The UE 115 may then concatenate the set of service data units to generate a concatenated service data unit in accordance with a concatenation policy generated by a machine learning model based on radio conditions associated with the set of service data units, a traffic type associated with the set of service data units, an internal condition associated with the UE 115, a network configuration including a range threshold or a performance threshold or both, or any combination thereof. The UE 115 may transmit the uplink transmission including the concatenated service data unit.

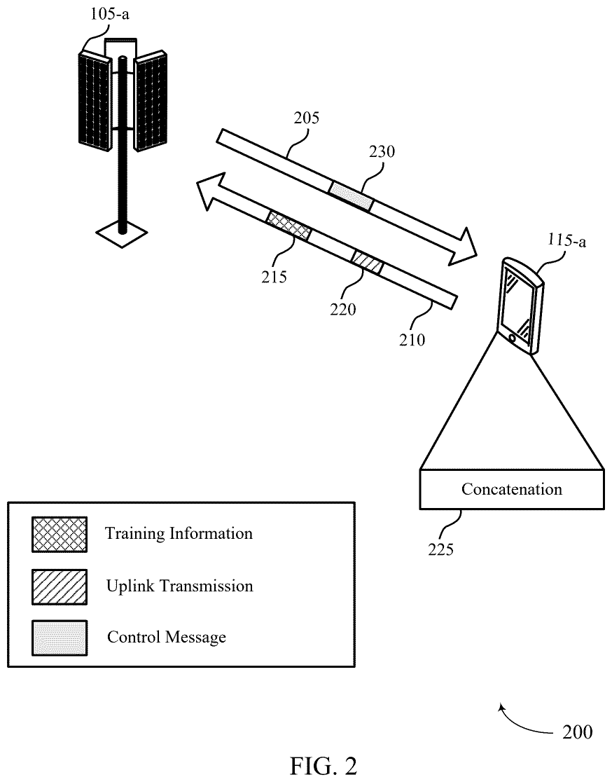

FIG. 2 shows an example of a wireless communications system 200 that supports techniques for protocol data unit size determination in accordance with one or more aspects of the present disclosure. The wireless communications system 200 may implement or may be implemented by aspects of the wireless communications system 100. For example, the wireless communications system 200 may include a UE 115-a and a network entity 105-a, which may be examples of corresponding devices described with reference to FIG. 1. The UE 115-a and the network entity 105-a may communicate using a downlink communication link 205 and an uplink communication link 210.

The network entity 105-a and the UE 115-a may communicate in accordance with concatenation of multiple service data units. In some examples, the UE 115-a may concatenate a set of service data units in accordance with one or more parameters generated by a machine learning model. The machine learning model may be hosted at the network entity 105-a. Alternatively, the machine learning model may be hosted at a machine learning server (not shown).

According to one or more aspects depicted herein, the UE 115-a may receive, at the PDCP layer of the UE 115-a, a set of service data units for an uplink transmission. The PDCP layer at the UE 115-a may select a concatenated service data unit size and a concatenation format from the incoming service data units. The UE 115-a may concatenate (by concatenation process 225) the set of service data units to generate a concatenated service data unit in accordance with a concatenation policy generated by a machine learning model. The machine learning model may generate the concatenation policy based on radio conditions, a traffic type associated with the set of service data units, an internal condition associated with the UE 115-a, a network configuration including a range threshold or a performance threshold or both, or any combination thereof. In some cases, the radio condition may include a frequency of grant allocation, a transport block size, a HARQ success rate, or any combination thereof. Additionally, or alternatively, the traffic type associated with the set of service data units may include latency sensitive traffic. In particular, latency sensitive traffic may prioritize communication over concatenation. Alternatively, traffic with low latency threshold may prioritize concatenation to reduce overhead and reduce processing. In some cases, the internal condition associated with the UE 115-a may include a processing capability, a power level of the UE 115-a (e.g., a battery level or a current power consumption), a throughput at the UE 115-a, or any combination thereof. For instance, the UE 115-a may implement concatenation at high throughput to reduce processing load. In some examples, the UE 115-a may concatenate the service data units to generate a protocol data unit by adding concatenation headers and other PDCP headers. For instance, the UE 115-a may transmit a protocol data unit including the concatenated service data unit, one or more concatenation headers and one or more PDCP headers.

In particular, the UE 115-a may report, to the network entity 105-a, one or more parameters as training information 215 for training the machine learning model. For instance, the UE 115-a may report a target concatenated service data unit size for the set of service data units, a target concatenation timer for the set of service data units, a set of logs associated with a set of concatenated service data unit sizes, a set of statistics associated with a set of concatenated service data unit sizes, a latency associated with concatenation buffering, one or more performance parameters, or any combination thereof. The one or more performance parameters may include at least one of a quantity of grants missed due to concatenation, an excess latency associated with concatenation, a throughput associated with concatenation, a channel occupancy time associated with concatenation, or any combination thereof. For instance, a quantity of grants may be missed if a size of the grants fail to accommodate (e.g., is not large) a size of a concatenated service data unit.

Upon receiving the training information 215, the machine learning model may use the training information 215 to train (initially) or further update the model. In particular, transmitting the training information 215 may ensure that the machine learning model can accurately predict a concatenation policy for every traffic flow. As described herein, the concatenation policy may be defined as the target concatenated service data unit size and concatenation timer tuple. In some examples, the concatenation policy may attempt to implement one or more network configured constraints or key performance indicators. Additionally, or alternatively, the machine learning model may predict transmission time or grant size of different traffic flows.

Accordingly, implementing the machine learning model (e.g., a machine learning model hosted at a machine learning server or a machine learning model hosted at the network entity 105-a), the UE 115-a may identify a policy on when to stop concatenating and transmit (or push) the concatenated service data units to the RLC buffer for uplink transmission. The UE 115-a, after generating the concatenated service data units, may transmit an uplink transmission 220 including the concatenated service data units.

In some examples, the UE 115-a may support a semi-static machine learning model or a dynamic machine learning model. In case of the semi-static machine learning model, the UE 115-a may report (e.g., in training information 215) a mapping of traffic flow to a target concatenated service data unit size and concatenation timer tuple. In case of the dynamic machine learning model, the UE 115-a may report statistics or logs on concatenation in terms of different concatenated service data unit sizes and latency attributed to concatenation buffering. Additionally, or alternatively, the UE 115-a may report an indication of one or more of an amount of grants missed due to concatenation, an excess latency incurred due to concatenation, a throughput supported with concatenation, and statistics about channel occupancy time acquired with the concatenation policy.

In some examples, the UE 115-a may indicate a capability to concatenate traffic, for example a maximum amount of concatenation streams available. For example, the UE 115-a may transmit a message indicating one or more of a capability of the UE 115-a to concatenate traffic with a threshold quantity of concatenation streams, a model accuracy, a throughput with concatenation supported at the UE 115-a, or any combination thereof. The model accuracy, in some cases, may be determined in terms of satisfaction of one or more key performance indicators. If the UE 115-a determines that layer 2 processing is the throughput bottleneck, the UE 115-a can report the indication of a throughput supported with concatenation.

In some cases, the UE 115-a may be configured (e.g., via RRC signaling) with a range configuration to be used during a PDCP size selection procedure. For example, the UE 115-a may receive a control message 230 including a set of configuration parameters associated with the concatenation policy. The set of configuration parameters can be configured per-bearer, per quality of service flow, per reordering-domain, or any traffic categorization. In some examples, the reordering domains may determine packets that are to be reordered together (e.g., Transmission Control Protocol (TCP) data and TCP ACKs are to be reordered separately).

In some examples, the set of configuration parameters may include a minimum time to hold service data units in a concatenation buffer (e.g., minConcatenationTimer) with its default being zero, a maximum time to hold service data units in the concatenation buffer (e.g., maxConcatenationTimer), a minimum size of concatenated service data units supported by the UE 115-a in bytes or service data units (e.g., minSDUTargetSize), a maximum size of concatenated service data units supported by the UE 115-a in bytes or service data units (e.g., maxSDUTargetSize), an indication of whether a use of the machine learning model is allowed (e.g., AIML_Allowed flag set to true (1) or false (0)), an indication of one or more quality of service flows associated with the machine learning model (e.g., QoSFlowsAllowed), or any combination thereof.

In some examples, the UE 115-a may be configured with one or more target key performance indicators. For instance, the UE 115-a may receive a control message 230 indicating the key performance indicators. As described herein, the concatenation policy (generated by the machine learning model) may be based on the control message 230. The UE 115-a may attempt to satisfy the one or more target key performance indicators when determining the concatenation or protocol data unit size at the receiver. In some cases, the control message 230 may indicate a threshold quantity of missed grants (e.g., GrantsMissed). The key performance indicator may indicate the amount of grants the UE misses while buffering service data units for concatenation. In some examples, the network entity 105-a may mandate that not more than 1% of uplink resources are to be missed due to concatenation. In some examples, the control message 230 may indicate a target segmentation rate (e.g., SegmentationRate) further indicating a quantity of concatenated service data units that can be segmented in the RLC entity. In some cases, excessive segmentation may mean that UE is over-concatenating. The control message 230 may further indicate a target throughput value describing a target flow throughput (e.g., TargetTput) for the concatenated service data units at the UE 115-a. Additionally, or alternatively, the control message 230 may indicate a target latency value (e.g., TargetLatency) describing a target end-to-end latency that the UE 115-a is to take into account when concatenating. Thus, utilizing the machine learning model in generating a concatenation policy, the UE 115-a can efficiently communicate using concatenated service data units generated in accordance with the concatenation policy.

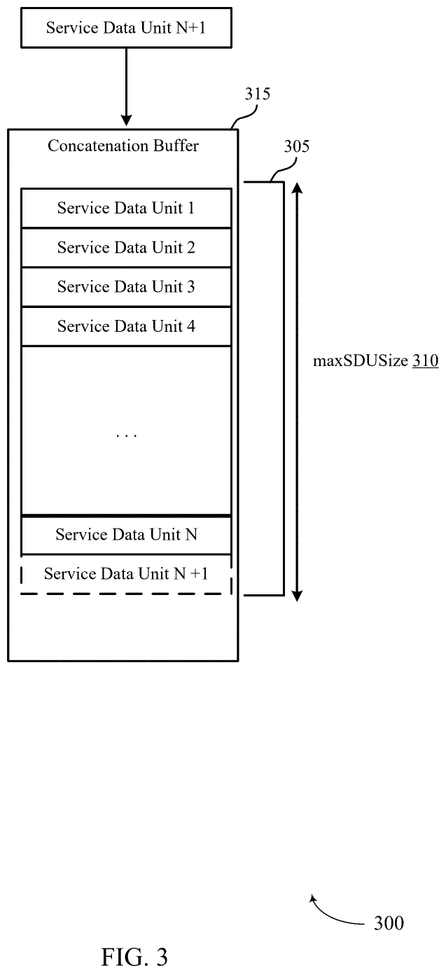

FIG. 3 shows an example of a concatenated service data unit structure 300 that supports techniques for protocol data unit size determination in accordance with one or more aspects of the present disclosure. The concatenated service data unit structure 300 may implement or may be implemented by aspects of the wireless communications system 100 and the wireless communications system 200. For example, the concatenated service data unit structure 300 may be implemented by a UE 115 and a network entity 105, which may be examples of corresponding devices described with reference to FIGS. 1 and 2.

As depicted in the example of FIG. 3, the UE 115 may receive a set of service data units at the PDCP layer of the UE 115. For instance, the UE 115 may receive service data unit 1 followed by service data unit 2, followed by service data unit 3. The UE 115 may generate a concatenated service data unit 305 without an uplink split and duplication. The concatenated service data unit 305 may be adaptive or non-adaptive to channel quality. In some cases, all service data units may be concatenated using the same rule (without quality of service flow separation).

In some cases, the UE 115 may concatenate the service data units using two parameters, a concatenation timer and a maximum concatenated service data unit size (maxSDUSize 310). In some examples, the UE 115 may add incoming service data units in a concatenation buffer 315. The concatenation buffer 315 may maintain a variable Concatenated_SDU_Size representing the cumulative size in bytes of all service data units in the buffer. According to one or more aspects depicted herein, the concatenation timer may be set according to the maximum allowable delay of the bearer or quality of service flow. Alternatively, the concatenation timer may be a UE implementation choice. In some examples, the maximum concatenated service data unit size may be a UE implementation choice or may be set according to a combination of factors. The factors may include one or more of a UE capability indicated by the UE 115 or network considerations such as lower bound on a typical grant size, channel occupancy time in NR-U, etc.

The UE 115 may use a machine learning model to determine a concatenation policy for a set of service data units. For example, the concatenation policy may indicate the maxSDUsize 310 or a concatenation timer or both. The UE 115 may be configured to concatenate service data units in the concatenation buffer until a configured size is exceeded or the concatenation timer elapses. If the concatenation timer elapses, then the UE 115 may forward the contents of the concatenation buffer 315 as a single concatenated service data unit 305. If the concatenation timer does not elapse, then after arrival of a new service data unit (e.g., service data unit N+1) at the concatenation buffer 315, if the sum of the new service data unit size and the concatenated service data unit size is greater than or equal to maxSDUSize, then the UE 115 may forward the contents of the concatenation buffer as a single concatenated service data unit and flush the contents of the concatenation buffer. In particular, the UE 115 may place the new service data unit into the concatenation buffer 315 and set concatenated service data unit size to be the new service data unit size. The UE 115 may then stop and restart the concatenation timer. On the other hand, if the sum of the new service data unit size and the concatenated service data unit size is less than maxSDUSize, then the UE 115 may concatenate new service data unit (service data unit N+1) in the concatenated service data unit 305 in the concatenation buffer 315. The concatenated service data unit size may be set as the sum of the previous concatenated service data unit size and new service data unit size. As depicted in the example of FIG. 3, the new service data unit N+1 is added to the concatenated service data unit 305 in the concatenation buffer as the total size of the concatenated service data unit 305 satisfied the maxSDUsize 310.

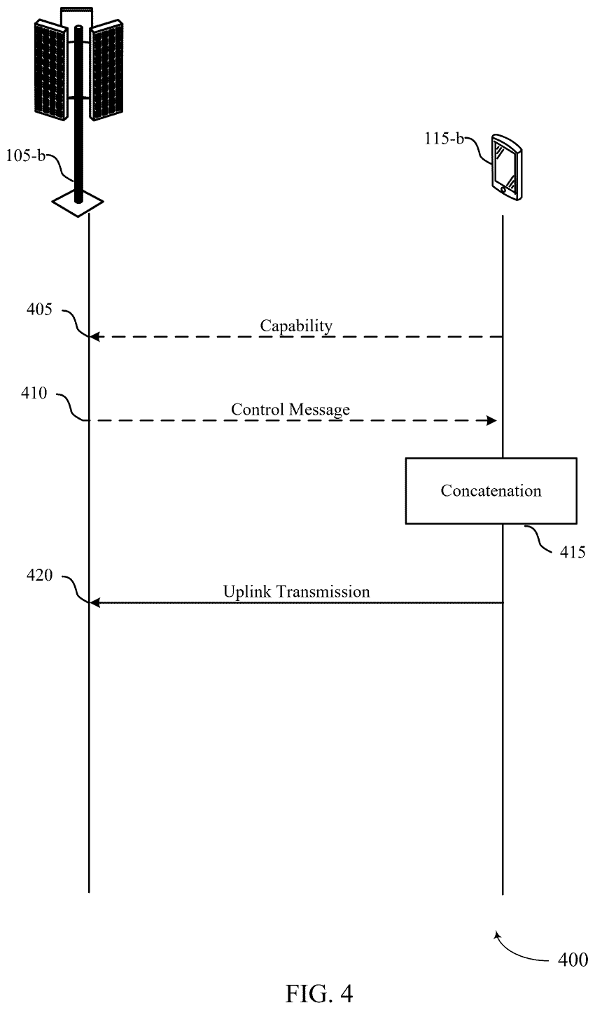

FIG. 4 shows an example of a process flow 400 that supports techniques for protocol data unit size determination in accordance with one or more aspects of the present disclosure. The process flow 400 includes a UE 115-b and a network entity 105-b, which may be examples of the corresponding devices as described with respect to FIGS. 1 and 2.

In the following description of the process flow 400, the operations between the UE 115-b and the network entity 105-b may be performed in a different order than the example order shown. Some operations may also be omitted from the process flow 400, and other operations may be added to the process flow 400. Further, although some operations or signaling may be shown to occur at different times for discussion purposes, these operations may actually occur at the same time.

At 405, the UE 115-b may optionally transmit, to the network entity 105-b, a message indicating one or more of a capability of the UE to concatenate traffic with a threshold quantity of concatenation streams, a model accuracy, a throughput with concatenation supported at the UE, or any combination thereof. As described in the example of FIG. 2, the UE 115-b may indicate a capability to concatenate traffic.

At 410, the UE 115-b may optionally receive a control message including a set of configuration parameters associated with a concatenation policy. The set of configuration parameters may include a minimum time to hold service data units in a concatenation buffer, a maximum time to hold service data units in the concatenation buffer, a minimum size of concatenated service data units supported by the UE, a maximum size of concatenated service data units supported by the UE, an indication of whether a use of the machine learning model is allowed, one or more quality of service flows associated with the machine learning model, or any combination thereof.

At 415, the UE 115-b may receive, at a PDCP layer of the UE 115-b, a set of service data units for an uplink transmission. The UE 115-b may then concatenate the set of service data units to generate a concatenated service data unit in accordance with a concatenation policy generated by a machine learning model based on a radio condition, a traffic type associated with the set of service data units, an internal condition associated with the UE, a network configuration including a range threshold or a performance threshold or both, or any combination thereof. As described in the example of FIG. 3, the UE 115-b may generate a concatenated service data unit in a concatenation buffer based on a total size of the concatenated service data unit satisfying a maximum service data unit size.

At 420, the UE 115-b may transmit the uplink transmission including the concatenated service data unit.

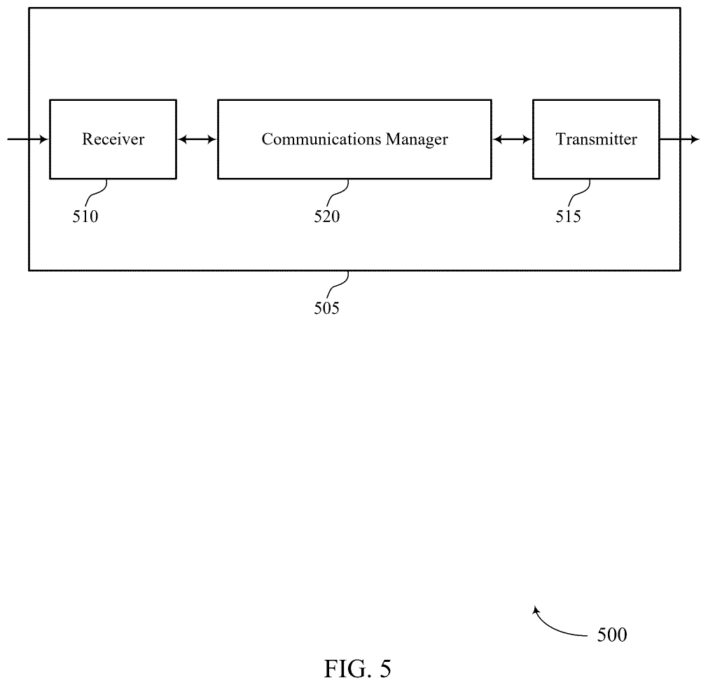

FIG. 5 shows a block diagram 500 of a device 505 that supports techniques for protocol data unit size determination in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for protocol data unit size determination). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for protocol data unit size determination). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for protocol data unit size determination as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, at a PDCP layer of the UE, a set of multiple service data units for an uplink transmission. The communications manager 520 is capable of, configured to, or operable to support a means for concatenating the set of multiple service data units to generate a concatenated service data unit in accordance with a concatenation policy generated by a machine learning model based on a radio condition, a traffic type associated with the set of multiple service data units, an internal condition associated with the UE, a network configuration including a range threshold or a performance threshold or both, or any combination thereof. The communications manager 520 is capable of, configured to, or operable to support a means for transmitting the uplink transmission including the concatenated service data unit.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

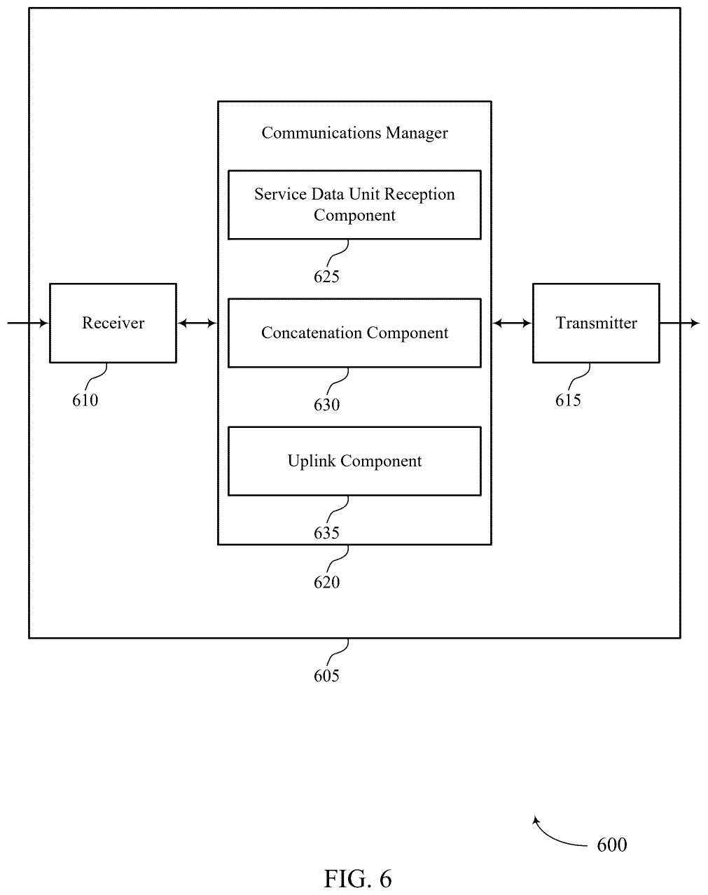

FIG. 6 shows a block diagram 600 of a device 605 that supports techniques for protocol data unit size determination in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for protocol data unit size determination). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for protocol data unit size determination). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for protocol data unit size determination as described herein. For example, the communications manager 620 may include a service data unit reception component 625, a concatenation component 630, an uplink component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The service data unit reception component 625 is capable of, configured to, or operable to support a means for receiving, at a PDCP layer of the UE, a set of multiple service data units for an uplink transmission. The concatenation component 630 is capable of, configured to, or operable to support a means for concatenating the set of multiple service data units to generate a concatenated service data unit in accordance with a concatenation policy generated by a machine learning model based on a radio condition, a traffic type associated with the set of multiple service data units, an internal condition associated with the UE, a network configuration including a range threshold or a performance threshold or both, or any combination thereof. The uplink component 635 is capable of, configured to, or operable to support a means for transmitting the uplink transmission including the concatenated service data unit.

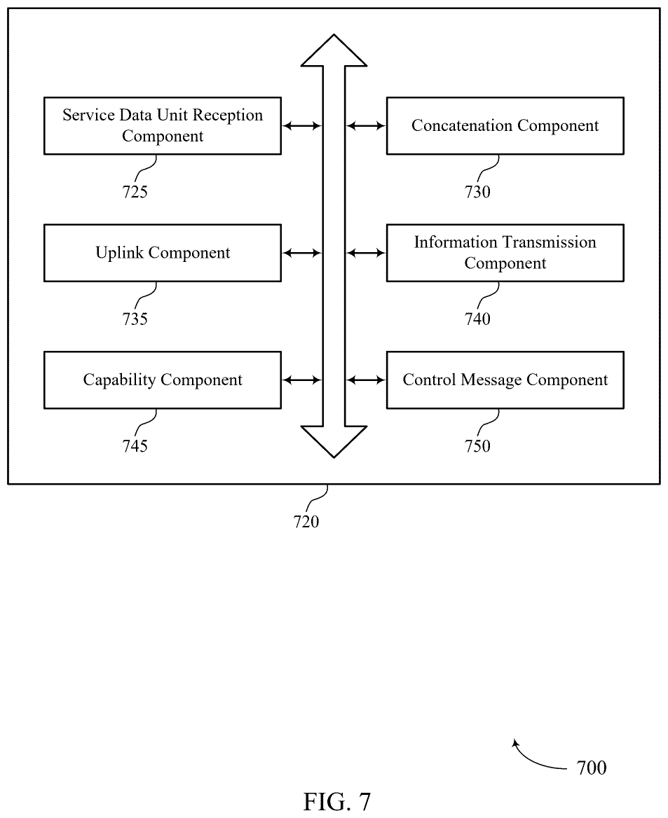

FIG. 7 shows a block diagram 700 of a communications manager 720 that supports techniques for protocol data unit size determination in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for protocol data unit size determination as described herein. For example, the communications manager 720 may include a service data unit reception component 725, a concatenation component 730, an uplink component 735, an information transmission component 740, a capability component 745, a control message component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The service data unit reception component 725 is capable of, configured to, or operable to support a means for receiving, at a PDCP layer of the UE, a set of multiple service data units for an uplink transmission. The concatenation component 730 is capable of, configured to, or operable to support a means for concatenating the set of multiple service data units to generate a concatenated service data unit in accordance with a concatenation policy generated by a machine learning model based on a radio condition, a traffic type associated with the set of multiple service data units, an internal condition associated with the UE, a network configuration including a range threshold or a performance threshold or both, or any combination thereof. The uplink component 735 is capable of, configured to, or operable to support a means for transmitting the uplink transmission including the concatenated service data unit.

In some examples, the information transmission component 740 is capable of, configured to, or operable to support a means for transmitting, to a server hosting the machine learning model or to a network entity, a target concatenated service data unit size for the set of multiple service data units, a target concatenation timer for the set of multiple service data units, a set of multiple logs associated with a set of multiple concatenated service data unit sizes, a set of multiple statistics associated with a set of multiple concatenated service data unit sizes, a latency associated with concatenation buffering, one or more performance parameters, or any combination thereof.

In some examples, the one or more performance parameters include at least one of a quantity of grants missed due to concatenation, an excess latency associated with concatenation, a throughput associated with concatenation, a channel occupancy time associated with concatenation, or any combination thereof.

In some examples, the capability component 745 is capable of, configured to, or operable to support a means for transmitting a message indicating one or more of a capability of the UE to concatenate traffic with a threshold quantity of concatenation streams, a model accuracy, a throughput with concatenation supported at the UE, or any combination thereof.

In some examples, to support transmitting the uplink transmission, the uplink component 735 is capable of, configured to, or operable to support a means for transmitting a protocol data unit including the concatenated service data unit, one or more concatenation headers and one or more PDCP headers. In some examples, the control message component 750 is capable of, configured to, or operable to support a means for receiving a control message including a set of configuration parameters associated with the concatenation policy.

In some examples, the set of configuration parameters includes a minimum time to hold service data units in a concatenation buffer, a maximum time to hold service data units in the concatenation buffer, a minimum size of concatenated service data units supported by the UE, a maximum size of concatenated service data units supported by the UE, an indication of whether a use of the machine learning model is allowed, one or more quality of service flows associated with the machine learning model, or any combination thereof.

In some examples, the control message component 750 is capable of, configured to, or operable to support a means for receiving a control message indicating a threshold quantity of missed grants, a target segmentation rate, a target throughput value, a target latency value, or any combination thereof, where the concatenation policy is based on the control message.

In some examples, the concatenation policy includes a concatenated service data unit size for the set of multiple service data units or a concatenation timer for the set of multiple service data units, or both. In some examples, the concatenation policy is configured for each bearer, each quality of service flow, each reordering domain, each traffic categorization, or any combination thereof.

In some examples, the radio condition includes a frequency of grant allocation, a transport block size, a hybrid automatic repeat request success rate, or any combination thereof.

In some examples, the traffic type associated with the set of multiple service data units includes a latency sensitive traffic. In some examples, the internal condition associated with the UE includes a processing capability, a power of the UE, a throughput at the UE, or any combination thereof.

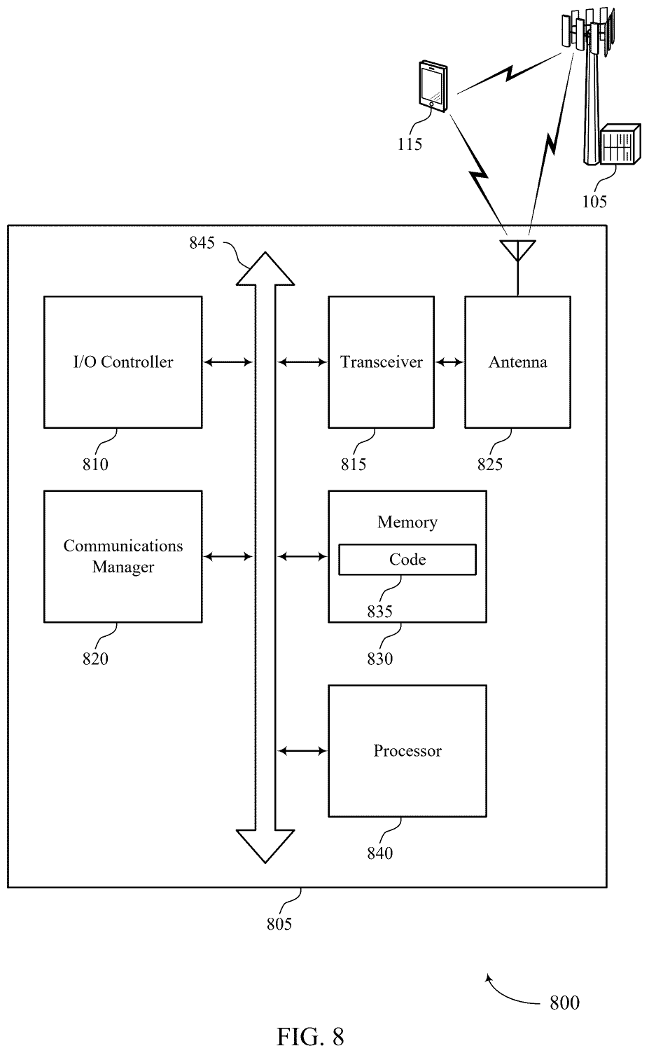

FIG. 8 shows a diagram of a system 800 including a device 805 that supports techniques for protocol data unit size determination in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for protocol data unit size determination). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, at a PDCP layer of the UE, a set of multiple service data units for an uplink transmission. The communications manager 820 is capable of, configured to, or operable to support a means for concatenating the set of multiple service data units to generate a concatenated service data unit in accordance with a concatenation policy generated by a machine learning model based on a radio condition, a traffic type associated with the set of multiple service data units, an internal condition associated with the UE, a network configuration including a range threshold or a performance threshold or both, or any combination thereof. The communications manager 820 is capable of, configured to, or operable to support a means for transmitting the uplink transmission including the concatenated service data unit.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for protocol data unit size determination as described herein, or the at least one processor 840 and the at least one memory 830 may be otherwise configured to, individually or collectively, perform or support such operations.

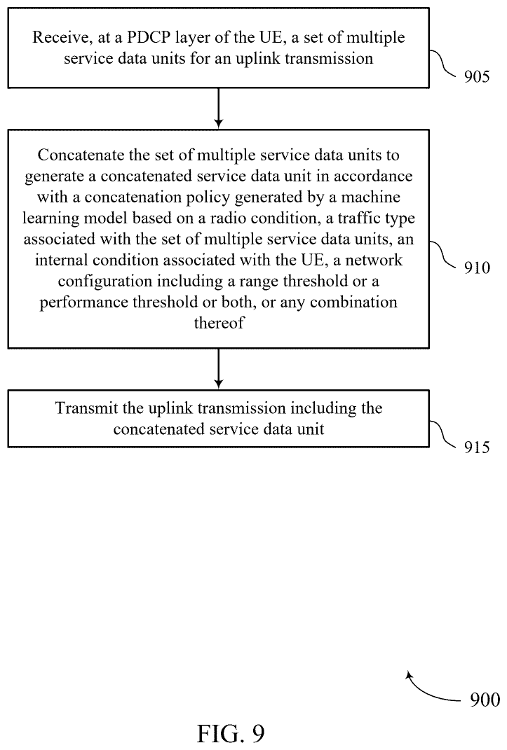

FIG. 9 shows a flowchart illustrating a method 900 that supports techniques for protocol data unit size determination in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving, at a PDCP layer of the UE, a set of multiple service data units for an uplink transmission. The operations of 905 may be performed in accordance with examples as disclosed herein. In some examples, aspects of the operations of 905 may be performed by a service data unit reception component 725 as described with reference to FIG. 7.

At 910, the method may include concatenating the set of multiple service data units to generate a concatenated service data unit in accordance with a concatenation policy generated by a machine learning model based on a radio condition, a traffic type associated with the set of multiple service data units, an internal condition associated with the UE, a network configuration including a range threshold or a performance threshold or both, or any combination thereof. The operations of 910 may be performed in accordance with examples as disclosed herein. In some examples, aspects of the operations of 910 may be performed by a concatenation component 730 as described with reference to FIG. 7.

At 915, the method may include transmitting the uplink transmission including the concatenated service data unit. The operations of 915 may be performed in accordance with examples as disclosed herein. In some examples, aspects of the operations of 915 may be performed by an uplink component 735 as described with reference to FIG. 7.

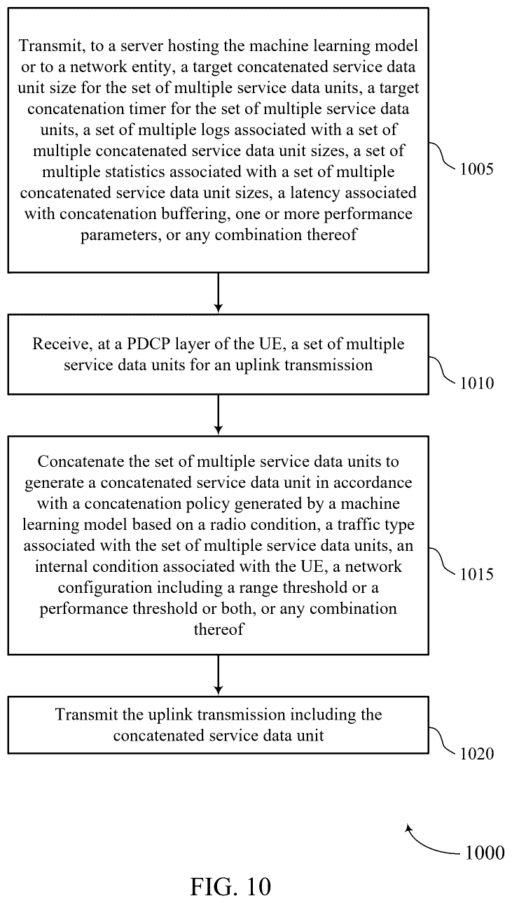

FIG. 10 shows a flowchart illustrating a method 1000 that supports techniques for protocol data unit size determination in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include transmitting, to a server hosting the machine learning model or to a network entity, a target concatenated service data unit size for the set of multiple service data units, a target concatenation timer for the set of multiple service data units, a set of multiple logs associated with a set of multiple concatenated service data unit sizes, a set of multiple statistics associated with a set of multiple concatenated service data unit sizes, a latency associated with concatenation buffering, one or more performance parameters, or any combination thereof. The operations of 1005 may be performed in accordance with examples as disclosed herein. In some examples, aspects of the operations of 1005 may be performed by an information transmission component 740 as described with reference to FIG. 7.

At 1010, the method may include receiving, at a PDCP layer of the UE, a set of multiple service data units for an uplink transmission. The operations of 1010 may be performed in accordance with examples as disclosed herein. In some examples, aspects of the operations of 1010 may be performed by a service data unit reception component 725 as described with reference to FIG. 7.

At 1015, the method may include concatenating the set of multiple service data units to generate a concatenated service data unit in accordance with a concatenation policy generated by a machine learning model based on a radio condition, a traffic type associated with the set of multiple service data units, an internal condition associated with the UE, a network configuration including a range threshold or a performance threshold or both, or any combination thereof. The operations of 1015 may be performed in accordance with examples as disclosed herein. In some examples, aspects of the operations of 1015 may be performed by a concatenation component 730 as described with reference to FIG. 7.

At 1020, the method may include transmitting the uplink transmission including the concatenated service data unit. The operations of 1020 may be performed in accordance with examples as disclosed herein. In some examples, aspects of the operations of 1020 may be performed by an uplink component 735 as described with reference to FIG. 7.

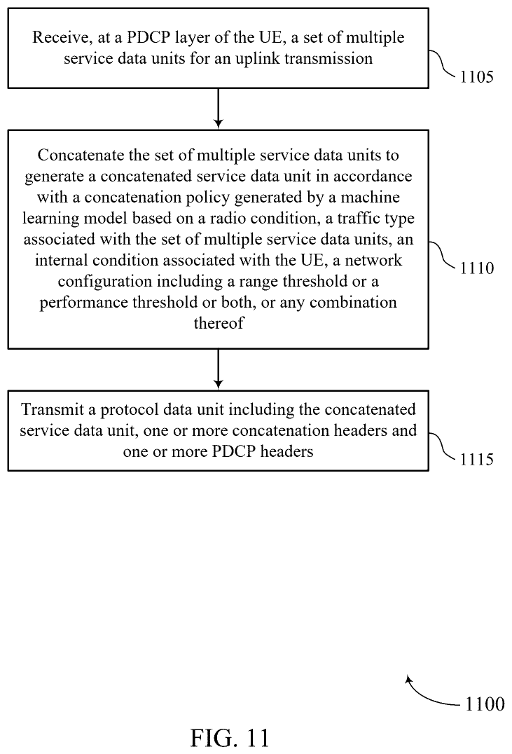

FIG. 11 shows a flowchart illustrating a method 1100 that supports techniques for protocol data unit size determination in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving, at a PDCP layer of the UE, a set of multiple service data units for an uplink transmission. The operations of 1105 may be performed in accordance with examples as disclosed herein. In some examples, aspects of the operations of 1105 may be performed by a service data unit reception component 725 as described with reference to FIG. 7.

At 1110, the method may include concatenating the set of multiple service data units to generate a concatenated service data unit in accordance with a concatenation policy generated by a machine learning model based on a radio condition, a traffic type associated with the set of multiple service data units, an internal condition associated with the UE, a network configuration including a range threshold or a performance threshold or both, or any combination thereof. The operations of 1110 may be performed in accordance with examples as disclosed herein. In some examples, aspects of the operations of 1110 may be performed by a concatenation component 730 as described with reference to FIG. 7.

At 1115, the method may include transmitting a protocol data unit including the concatenated service data unit, one or more concatenation headers and one or more PDCP headers. The operations of 1115 may be performed in accordance with examples as disclosed herein. In some examples, aspects of the operations of 1115 may be performed by an uplink component 735 as described with reference to FIG. 7.

The following provides an overview of aspects of the present disclosure:

Aspect 1: A method for wireless communications at a UE, comprising: receiving, at a packet data converge protocol layer of the UE, a plurality of service data units for an uplink transmission; concatenating the plurality of service data units to generate a concatenated service data unit in accordance with a concatenation policy generated by a machine learning model based at least in part on a radio condition associated with the plurality of service data units, a traffic type associated with the plurality of service data units, an internal condition associated with the UE, a network configuration comprising a range threshold or a performance threshold or both, or any combination thereof; and transmitting the uplink transmission comprising the concatenated service data unit.

Aspect 2: The method of aspect 1, further comprising: transmitting, to a server hosting the machine learning model or to a network entity, a target concatenated service data unit size for the plurality of service data units, a target concatenation timer for the plurality of service data units, a plurality of logs associated with a plurality of concatenated service data unit sizes, a plurality of statistics associated with a plurality of concatenated service data unit sizes, a latency associated with concatenation buffering, one or more performance parameters, or any combination thereof.

Aspect 3: The method of aspect 2, wherein the one or more performance parameters comprise at least one of a quantity of grants missed due to concatenation, an excess latency associated with concatenation, a throughput associated with concatenation, a channel occupancy time associated with concatenation, or any combination thereof.

Aspect 4: The method of any of aspects 1 through 3, further comprising: transmitting a message indicating one or more of a capability of the UE to concatenate traffic with a threshold quantity of concatenation streams, a model accuracy, a throughput with concatenation supported at the UE, or any combination thereof.

Aspect 5: The method of any of aspects 1 through 4, wherein transmitting the uplink transmission further comprises: transmitting a protocol data unit comprising the concatenated service data unit, one or more concatenation headers and one or more packet data converge protocol headers.

Aspect 6: The method of any of aspects 1 through 5, further comprising: receiving a control message comprising a set of configuration parameters associated with the concatenation policy.

Aspect 7: The method of aspect 6, wherein the set of configuration parameters comprises a minimum time to hold service data units in a concatenation buffer, a maximum time to hold service data units in the concatenation buffer, a minimum size of concatenated service data units supported by the UE, a maximum size of concatenated service data units supported by the UE, an indication of whether a use of the machine learning model is allowed, one or more quality of service flows associated with the machine learning model, or any combination thereof.

Aspect 8: The method of any of aspects 1 through 7, further comprising: receiving a control message indicating a threshold quantity of missed grants, a target segmentation rate, a target throughput value, a target latency value, or any combination thereof, wherein the concatenation policy is based at least in part on the control message.

Aspect 9: The method of any of aspects 1 through 8, wherein the concatenation policy comprises a concatenated service data unit size for the plurality of service data units or a concatenation timer for the plurality of service data units, or both.

Aspect 10: The method of any of aspects 1 through 9, wherein the concatenation policy is configured for each bearer, each quality of service flow, each reordering domain, each traffic categorization, or any combination thereof.

Aspect 11: The method of any of aspects 1 through 10, wherein the radio condition associated with the plurality of service data units comprises a frequency of grant allocation, a transport block size, a hybrid automatic repeat request success rate, or any combination thereof.

Aspect 12: The method of any of aspects 1 through 11, wherein the traffic type associated with the plurality of service data units comprises a latency sensitive traffic.

Aspect 13: The method of any of aspects 1 through 12, wherein the internal condition associated with the UE comprises a processing capability, a power of the UE, a throughput at the UE, or any combination thereof.

Aspect 14: A UE for wireless communications, comprising one or more memories storing processor-executable code, and one or more processors coupled with the one or more memories and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples. ” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, at a packet data convergence protocol layer of the UE, a plurality of service data units for an uplink transmission;
concatenate the plurality of service data units to generate a concatenated service data unit in accordance with a concatenation policy generated by a machine learning model based at least in part on a radio condition, a traffic type associated with the plurality of service data units, an internal condition associated with the UE, a network configuration comprising a range threshold or a performance threshold or both, or any combination thereof; and
transmit the uplink transmission comprising the concatenated service data unit.

2. The UE of claim 1, wherein the one or more processors are individually or collectively further operable to execute the code to cause the UE to:
transmit, to a server hosting the machine learning model or to a network entity, a target concatenated service data unit size for the plurality of service data units, a target concatenation timer for the plurality of service data units, a plurality of logs associated with a plurality of concatenated service data unit sizes, a plurality of statistics associated with a plurality of concatenated service data unit sizes, a latency associated with concatenation buffering, one or more performance parameters, or any combination thereof.

3. The UE of claim 2, wherein the one or more performance parameters comprise at least one of a quantity of grants missed due to concatenation, an excess latency associated with concatenation, a throughput associated with concatenation, a channel occupancy time associated with concatenation, or any combination thereof.

4. The UE of claim 1, wherein the one or more processors are individually or collectively further operable to execute the code to cause the UE to:
transmit a message indicating one or more of a capability of the UE to concatenate traffic with a threshold quantity of concatenation streams, a model accuracy, a throughput with concatenation supported at the UE, or any combination thereof.

5. The UE of claim 1, wherein, to transmit the uplink transmission, the one or more processors are individually or collectively further operable to execute the code to cause the UE to:
transmit a protocol data unit comprising the concatenated service data unit, one or more concatenation headers and one or more packet data convergence
protocol headers.

6. The UE of claim 1, wherein the one or more processors are individually or collectively further operable to execute the code to cause the UE to:
receive a control message comprising a set of configuration parameters associated with the concatenation policy.

7. The UE of claim 6, wherein the set of configuration parameters comprises a minimum time to hold service data units in a concatenation buffer, a maximum time to hold service data units in the concatenation buffer, a minimum size of concatenated service data units supported by the UE, a maximum size of concatenated service data units supported by the UE, an indication of whether a use of the machine learning model is allowed, one or more quality of service flows associated with the machine learning model, or any combination thereof.

8. The UE of claim 1, wherein the one or more processors are individually or collectively further operable to execute the code to cause the UE to:
receive a control message indicating a threshold quantity of missed grants, a target segmentation rate, a target throughput value, a target latency value, or any combination thereof, wherein the concatenation policy is based at least in part on the control message.

9. The UE of claim 1, wherein the concatenation policy comprises a concatenated service data unit size for the plurality of service data units or a concatenation timer for the plurality of service data units, or both.

10. The UE of claim 1, wherein the concatenation policy is configured for each bearer, each quality of service flow, each reordering domain, each traffic categorization, or any combination thereof.

11. The UE of claim 1, wherein the radio condition comprises a frequency of grant allocation, a transport block size, a hybrid automatic repeat request success rate, or any combination thereof.

12. The UE of claim 1, wherein the traffic type associated with the plurality of service data units comprises a latency sensitive traffic.

13. The UE of claim 1, wherein the internal condition associated with the UE comprises a processing capability, a power of the UE, a throughput at the UE, or any combination thereof.

14. A method for wireless communications at a user equipment (UE), comprising:
receiving, at a packet data convergence protocol layer of the UE, a plurality of service data units for an uplink transmission;
concatenating the plurality of service data units to generate a concatenated service data unit in accordance with a concatenation policy generated by a machine learning model based at least in part on a radio condition, a traffic type associated with the plurality of service data units, an internal condition associated with the UE, a network configuration comprising a range threshold or a performance threshold or both, or any combination thereof; and
transmitting the uplink transmission comprising the concatenated service data unit.

15. The method of claim 14, further comprising:
transmitting, to a server hosting the machine learning model or to a network entity, a target concatenated service data unit size for the plurality of service data units, a target concatenation timer for the plurality of service data units, a plurality of logs associated with a plurality of concatenated service data unit sizes, a plurality of statistics associated with a plurality of concatenated service data unit sizes, a latency associated with concatenation buffering, one or more performance parameters, or any combination thereof.

16. The method of claim 15, wherein the one or more performance parameters comprise at least one of a quantity of grants missed due to concatenation, an excess latency associated with concatenation, a throughput associated with concatenation, a channel occupancy time associated with concatenation, or any combination thereof.

17. The method of claim 14, further comprising:
transmitting a message indicating one or more of a capability of the UE to concatenate traffic with a threshold quantity of concatenation streams, a model accuracy, a throughput with concatenation supported at the UE, or any combination thereof.

18. The method of claim 14, wherein transmitting the uplink transmission further comprises:
transmitting a protocol data unit comprising the concatenated service data unit, one or more concatenation headers and one or more packet data convergence protocol headers.

19. The method of claim 14, further comprising:
receiving a control message comprising a set of configuration parameters associated with the concatenation policy.

20. A non-transitory computer-readable medium storing code for wireless communications at a user equipment (UE), the code comprising instructions executable by one or more processors to:
receive, at a packet data convergence protocol layer of the UE, a plurality of service data units for an uplink transmission;
concatenate the plurality of service data units to generate a concatenated service data unit in accordance with a concatenation policy generated by a machine learning model based at least in part on a radio condition, a traffic type associated with the plurality of service data units, an internal condition associated with the UE, a network configuration comprising a range threshold or a performance threshold or both, or any combination thereof; and
transmit the uplink transmission comprising the concatenated service data unit.
